(19) United States
(12) Patent Application Publication
(10) Pub. No.: US 2015/0130695 A1
(43) Pub. Date: May 14, 2015

(54) CAMERA BASED AUTO SCREEN ROTATION

(71) Applicant: Jianjun Gu, Beijing (CN)

(72) Inventor: Jianjun Gu, Beijing (CN)

(21) Appl. No.: 13/977,027

(22) PCT Filed: Jun. 29, 2012
(86) PCT No.: PCT/CN2012/000888

§ 371 Date: Apr. 23, 2014

(51) Int. Cl. G06T 3/60; G06F 3/00

(52) U.S. Cl. CPC G06T 3/60; G06F 3/005; G06T 2207/10004
USPC 345/156

(57) ABSTRACT

Systems and methods may provide for receiving an image of a user of a mobile device and analyzing the image to determine whether a rotation condition is present with respect to the mobile device relative to a face of the user. Additionally, content on a screen of the mobile device may be rotated if the rotation condition. In one example, the analysis of the image includes identifying one or more of a head shape and an eye position in the image, wherein the image is received while the user is lying down.

### BACKGROUND

1. Technical Field

Embodiments generally relate to the viewing of content on mobile devices. More particularly, embodiments relate to the automatic rotation of screen content based on captured images of mobile device users.

2. Discussion

Mobile devices such as smart phones and smart tablets may be equipped with an “auto rotation” solution that rotates screen content in response to user rotations of the device (i.e., between portrait and landscape positions). More particularly, such solutions may use an on board gravity sensor to detect when the device has been rotated. While these solutions may be suitable under certain circumstances, there remains considerable room for improvement. For example, if the user lies down (e.g., on a bed or sofa) while keeping the device at the desired viewing position, the auto rotation feature may incorrectly assume that the screen content needs to be rotated because the gravity based rotation determination is made relative to the earth. As a result, the user experience with regard to viewing content on the mobile device can be negatively impacted. Indeed, some users may decide to disable the auto rotation feature altogether if they expect to view the device at any body position other than an upright (e.g., sitting or standing) position.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1A is a block diagram of an example of a user viewing sequence according to an embodiment;

FIG. 1B is an illustration of an example of a threshold angle according to an embodiment;

FIG. 2 is a flowchart of an example of a method of orienting screen content on a mobile device according to an embodiment; and

FIG. 3 is a block diagram of an example of a mobile platform according to an embodiment.

### DETAILED DESCRIPTION

Embodiments may include a method of orienting screen content on a mobile device in which an image of a user of the mobile device is received. The method may also provide for analyzing the image to determine whether a rotation condition is present with respect to the mobile device relative to a face of the user, and rotating content on a screen of the mobile device if the rotation condition is present.

Embodiments may also include a non-transitory computer readable storage medium having a set of instructions which, if executed by a processor, cause a mobile device to receive an image of a user of the mobile device. The instructions, if executed, may also cause the mobile device to analyze the image to determine whether a rotation condition is present with respect to the mobile device relative to a face of the user, and rotate content on a screen of the mobile device if the rotation condition is present.

Additionally, embodiments can include a mobile device having a screen to display content, a camera to capture an image of a user of the mobile device, and logic to receive the image of the user. The logic may also analyze the image to determine whether a rotation condition is present with respect to the device relative to a face of the user, and rotate the content on the screen of the mobile device if the rotation condition is present.

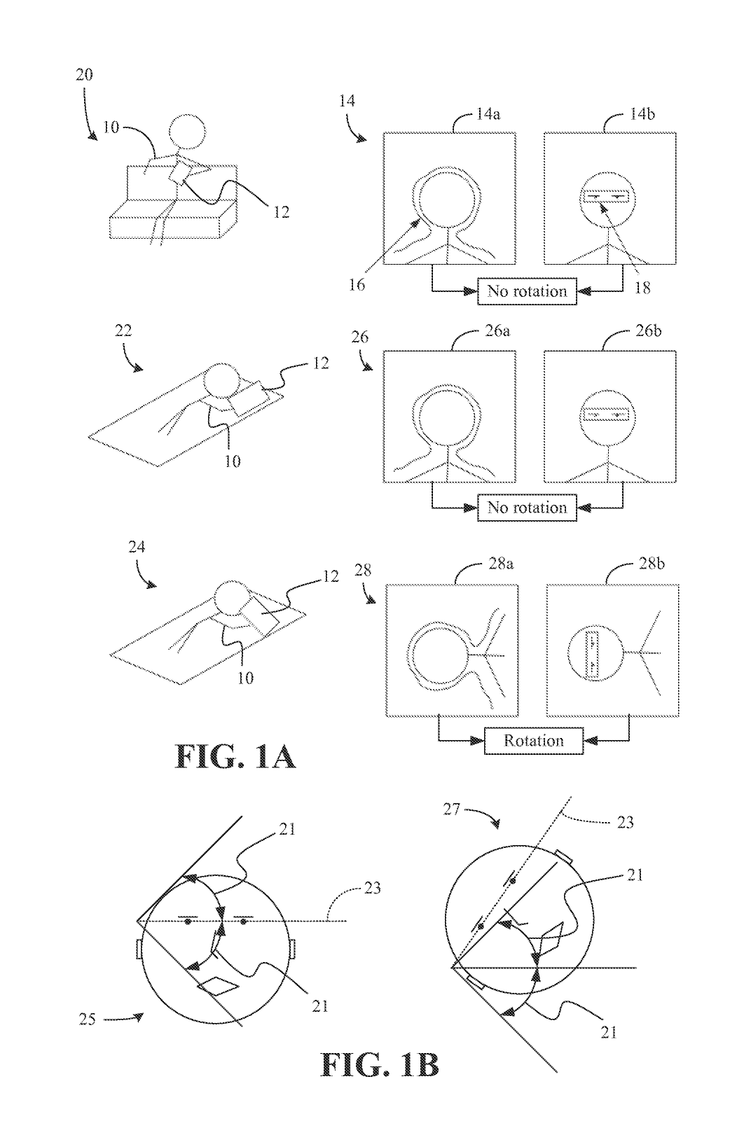

Turning now to FIG. 1A, a user viewing sequence is shown in which a user 10 views content on the screen of a mobile device 12 such as a smart phone, smart tablet, personal digital assistant (PDA), and so forth. In the illustrated example, both the head of the user 10 and the mobile device 12 are tilted slightly to the side at a first viewing stage 20, with the device 12 being in the portrait position. Rather than using an on board gravity sensor, the mobile device 12 may use a front facing camera of the device 12 to capture one or more images 14 (14a, 14b) of the face of the user 10 and conduct an analysis of the images 14 to determine whether a rotation condition is present with respect to the device 12 relative to the face of the user 10. The rotation condition could include/specify a rotation of the mobile device 12 beyond a threshold angle (e.g., 45°), wherein the analysis of an image 14a involves identifying a head shape 16 in the image 14a. Thus, if the head shape 16 indicates that the device 12 has been rotated beyond the threshold angle (relative to the face rather than the earth), the screen content may be also rotated in the same direction of the rotation of the device 12. Similarly, the analysis of an image 14b may involve identifying an eye position in the image to determine whether the rotation condition is present. Other face recognition and/or analysis techniques may also be used. In the illustrated example, the rotation condition is not present, so the screen content is not rotated.

At a second viewing stage 22, the user 10 is lying down with the mobile device 12 remaining in the portrait position relative to the face of the user 10. In the illustrated example, one or more images 26 (26a, 26b) are captured of the user 10, wherein the head shape and/or eye position of the images 26 demonstrate that the mobile device 12 has not been rotated significantly relative to the face of the user. Accordingly, no rotation of the screen content would be done by the illustrated mobile device 12. Of particular note is that a gravity sensor based approach would likely rotate the screen content, which can be inconvenient to the user 10. Thus, if the mobile device 12 includes a gravity sensor, the output of the gravity sensor may be disregarded in the illustrated approach.

At a third viewing stage 24, the user 10 is lying down with the mobile device 12 rotated to the landscape position relative to the face of the use 10. Accordingly, one or more images 28 (28a, 28b) of the user may be analyzed to determine that the head shape and/or eye position of the images 28 corresponds to a rotation of the mobile device 12 relative to the face of the user 10. The mobile device 12 may therefore rotate the content on the screen at viewing stage 24.

FIG. 1B shows an example of an image analysis in greater detail. In the illustrated example, a threshold angle 21 is defined relative to an eye position 23 detected in an image 25 of a user (e.g., while the user is viewing a mobile device in a portrait position). In a subsequent image 27 of the user, the eye position 23 has rotated beyond the threshold angle 21 in the positive direction. Accordingly, the content being shown on a display of the device may be rotated ninety degrees in the positive direction. While the eye position is used in the illustrated example, other facial features such as head shape, nose position, mouth position, ear position, and so forth, can also be used to detect the rotation condition. Moreover, the content rotation could be less than ninety degrees if, for example, a finer granularity of rotation is appropriate (e.g., specialized devices).

FIG. 2 shows a method 30 of orienting content on a screen of a mobile device. The method 30 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TIL) technology, or any combination thereof.

Illustrated processing block 32 provides for receiving an image of a user of a mobile device, wherein the image may include traditional two-dimensional (2D) image data and/or more advanced types of image data (e.g., three-dimensional/3D, infrared/IR, etc.) image data. For example, IR image data may be particularly useful in low light environments and/or special scenes. The image may be received from a front camera of the mobile device, wherein the image capture might be triggered by, for example, a traditional on board gravity sensor, a user request, a timer (e.g., periodically), and so forth. The image may be analyzed at block 34, wherein the analysis can involve, for example, identifying/recognizing a head shape and/or eye position in the image. Illustrated block 36 provides for determining whether a rotation condition is present with respect to the mobile device relative to a face of the user. As already discussed, the rotation condition may include a rotation of the mobile device beyond a particular threshold angle. If the rotation condition is present, block 38 may determine a rotation direction for the device based on the captured image, and rotate content on a screen of the mobile device based at least in part on the rotation direction associated with the rotation condition. In one example, the content is rotated ninety degrees. If the rotation condition is not present relative to the face of the user, no content rotation is conducted, in the illustrated example.

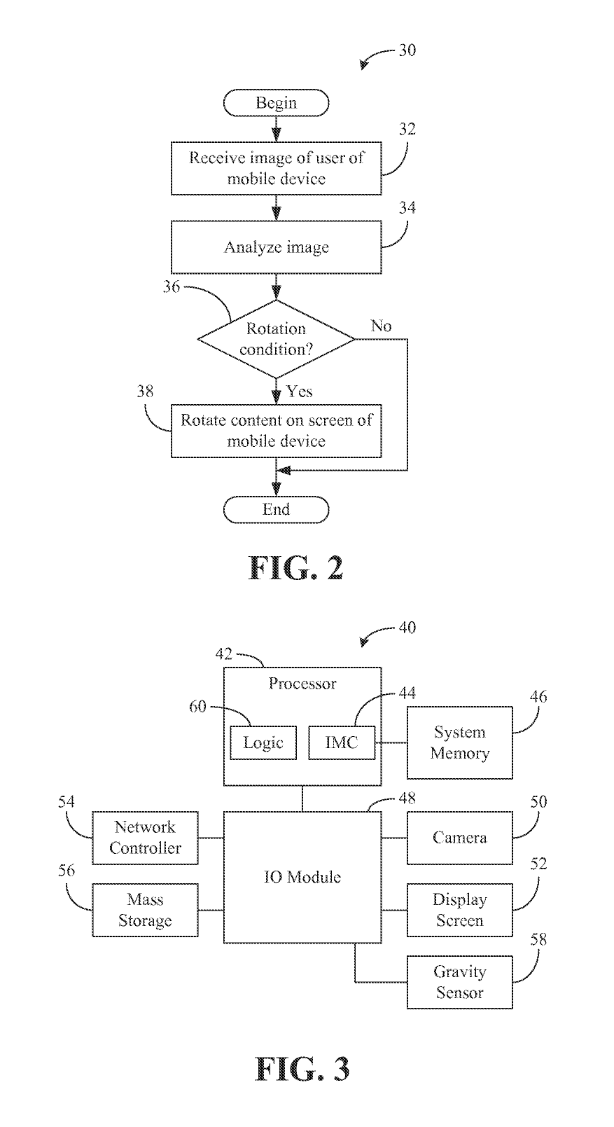

Turning now to FIG. 3 a mobile device 40 is shown, wherein the device 40 may have computing functionality (e.g., personal digital assistant/PDA, laptop, smart tablet), communications functionality (e.g., wireless smart phone), imaging functionality, media playing functionality (e.g., smart television/TV), or any combination thereof (e.g., mobile Internet device/MID). In the illustrated example, a processor 42 has an integrated memory controller (IMC) 44 that facilitates communication between the processor 42 and system memory 46, wherein the system memory 46 could include, for example, double data rate (DDR) synchronous dynamic random access memory (SDRAM, e.g., DDR3 SDRAM JEDEC Standard JESD79-3C, April 2008) modules. The modules of the system memory 46 may be incorporated into a single inline memory module (SIMM), dual inline memory module (DIMM), small outline DIMM (SODIMM), and so forth.

The illustrated device 40 also includes an IO module 48 that facilitates communication with a front camera 50, a display screen 52, a network controller 54, mass storage 56, a gravity sensor 58, and various other controllers, busses and/or modules (not shown). The processor 42 may include logic 60 configured to receive an image of a user of the device 40 from the camera 50, and analyze the image to determine whether a rotation condition is present with respect to the device relative to a face of the user. The logic 60 may also be configured to rotate content on the display screen 52 if the rotation condition is present, as already discussed. In one example, the logic 60 disregards an output of the gravity sensor 58 in determining whether to rotate the content on the display screen 52. Although the illustrated logic 60 is implemented in the processor 42, the logic 60 could also be implemented elsewhere in the mobile device 40. For example, the logic 60 may also be implemented in the IO module 48 or as a standalone logic block in a system on chip (SOC0 configuration that includes the processor 42, IO module 48, network controller 54, etc., on a single chip. Other configurations may also be used depending upon the circumstances.

Techniques described herein may therefore enable mobile device users to freely switch sitting positions while viewing content on the mobile device without concern over unwanted and/or unintended screen content rotations. Moreover, techniques may leverage pre-existing hardware as many mobile devices may be equipped with front facing cameras.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Moreover, any use of the terms “first”, “second”, etc., does not limit the embodiments discussed to the number of components listed.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1-27. (canceled)

28. A mobile device comprising:
a screen to display content;
a camera to capture an image of a user of the mobile device; and
logic to,
receive the image of the user,
analyze the image to determine whether a rotation condition is present with respect to the device relative to a face of the user, and rotate the content on the screen of the mobile device if the rotation
condition is present.

29. The mobile device of claim 28, wherein the rotation condition is to include a rotation of the mobile device beyond a threshold angle.

30. The mobile device of claim 28, wherein the logic is to identify a head shape in the image to determine whether the rotation condition is present.

31. The mobile device of claim 28, wherein the logic is to identify an eye position in the image to determine whether the rotation condition is present.

32. The mobile device of claim 28, wherein the logic is to rotate the content ninety degrees.

33. The mobile device of claim 32, wherein the logic is to determine a rotation direction for the content based at least in part on a rotation direction associated with the rotation condition.

34. The mobile device of claim 28, wherein the camera is a front camera.

35. The mobile device of claim 28, wherein the image is to be received while the user is lying down.

36. The mobile device of claim 28, further including a gravity sensor, wherein the logic is to disregard an output of the gravity sensor.

37. A method comprising:
receiving an image of a user of a mobile device;
analyzing the image to determine whether a rotation condition is present with respect to the mobile device relative to a face of the user; and
rotating content on a screen of the mobile device if the rotation condition is present.

38. The method of claim 37, wherein the rotation condition includes a rotation of the mobile device beyond a threshold angle.

39. The method of claim 37, wherein analyzing the image includes identifying a head shape in the image.

40. The method of claim 37, wherein analyzing the image includes identifying an eye position in the image.

41. The method of claim 37, wherein rotation the content includes rotating the content ninety degrees.

42. The method of claim 41, further including determining a rotation direction for the content based at least in part on a rotation direction associated with the rotation condition.

43. The method of claim 37, wherein the image is received from a front camera of the mobile device.

44. The method of claim 37, wherein the image is received while the user is lying down.

45. The method of claim 37, further including disregarding a gravity sensor output on the mobile device.

46. A non-transitory computer readable storage medium comprising a set of instructions which, if executed by a processor, cause a mobile device to:
receive an image of a user of the mobile device;
analyze the image to determine whether a rotation condition is present with respect to the mobile device relative to a face of the user; and
rotate content on a screen of the mobile device if the rotation condition is present.

47. The medium of claim 46, wherein the rotation condition is to include a rotation of the mobile device beyond a threshold angle.

48. The medium of claim 46, wherein the instructions, if executed, cause the mobile device to identify a head shape in the image to determine whether the rotation condition is present.

49. The medium of claim 46, wherein the instructions, if executed, cause the mobile device to identify an eye position in the image to determine whether the rotation condition is present.

50. The medium of claim 46, wherein the instructions, if executed, cause the mobile device to rotate the content ninety degrees.

51. The medium of claim 50, wherein the instructions, if executed, cause the mobile device to determine a rotation direction for the content based at least in part on a rotation direction associated with the rotation condition.

52. The medium of claim 46, wherein the image is to be received from a front camera of the mobile device.

53. The medium of claim 46, wherein the image is to be received while the user is lying down.

54. The medium of claim 46, wherein the instructions, if executed, cause the mobile device to disregard a gravity sensor output on the mobile device.
